(19) United States
(12) Patent Application Publication
(10) Pub. No.: US 2023/0318091 A1
(43) Pub. Date: Oct. 5, 2023

(54) CONTROL SYSTEM AND DESIGN FOR ADYNAMIC ADAPTIVE INTELLIGENT MULTI-CELL AIR BATTERY

(71) Applicant: AlumaPower Corporation, Sarnia (CA)

(72) Inventors: Geoffrey Sheerin, Sarnia (CA); Robert James Alexander, Huntsville (CA); William Terence D'Silva, Sarnia (CA)

(21) Appl. No.: 18/043,361

(22) PCT Filed: Aug. 31, 2021
(86) PCT No.: PCT/IB2021/057966

§ 371 Date: Feb. 28, 2023

Related U.S. Application Data
(60) Provisional application No. 63/072,572, filed on Aug. 31, 2020.

(51) Int. Cl. H01M 12/08; H01M 50/70

(52) U.S. Cl. CPC H01M 12/08; H01M 50/70; H01M 2220/20

(57) ABSTRACT

A control system is described to improve all dynamic, multi-cell metal air batteries to ensure load requirements are met while optimizing battery performance according to a range of performance criteria. This control system can be augmented with Machine Learning to further improve both the effectiveness and efficiency of the battery system over time. A dynamic multi-cell metal air battery system design is disclosed to achieve continuous or intermittent high power, broadening the applicability of metal air batteries combined with electric motors to applications traditionally reserved for internal combustion engines.

### CROSS-REFERENCE TO RELATED APPLICATIONS

This application claims priority to and is a non-provisional of U.S. Patent Application Ser. No. 63/072,572 (filed August 31, 2020) the entirety of which is incorporated herein by reference.

### BACKGROUND OF THE INVENTION

The subject matter disclosed herein relates to metal air batteries. Metal air batteries have attracted significant interest due to their high energy density relative to industry standards such as lithium ion batteries. Promising applications exist for mobile, portable, and stationary distributed power sources. Metal air batteries, in combination with other energy storage devices, have the potential to replace the internal combustion engines found in hybrid cars and aircraft since the energy density and efficiency of energy conversion approach those of hydrocarbon fuels, albeit without in situ air emissions.

Metal air batteries suffer from a number of problems that have, to date, excluded them from use in the aforementioned areas. Since the metal anode is consumed during the discharge of the battery, the distance between the cathode and anode increases over time. This change in electrode spacing increases the I2R (electrical resistance losses) lowering the power output over time. When the batteries are run open circuit or without load, they can rapidly produce hydrogen gas in the electrolyte that further increases both parasitic losses (due to hydrogen production) and local I2R losses which, in turn, can prevent return to full power output when connected to a closed electrical circuit again, sometimes due to the buildup of a coating (e.g. a gel) on the anode. Once the metal anode is consumed the battery must be dismantled so it can be mechanically recharged with fresh metal anodes before use. This process is performed in a shop making the turnaround time a barrier to frequent recharge and use of metal air batteries. Metal air batteries benefit from extremely high energy density when compared to current technologies such as lithium ion. However, their power density can be a limiting factor for applications requiring rapid power output (e.g., take off in aviation, or rapid acceleration in automotive) which in turn leads to a need for larger alternative sources of energy (e.g., lithium ion battery, or internal combustion engines or turbines).

The discussion above is merely provided for general background information and is not intended to be used as an aid in determining the scope of the claimed subject matter.

### SUMMARY

A control system is described to improve dynamic, multi-cell metal air batteries to ensure load requirements are met while optimizing battery performance according to a range of performance criteria. This control system can be augmented with Machine Learning to further improve both the effectiveness and efficiency of the battery system over time. A dynamic multi-cell metal air battery system design is disclosed to achieve continuous or intermittent high power, broadening the applicability of metal air batteries combined with electric motors to applications traditionally reserved for internal combustion engines.

A high-power design is disclosed that expands the power output range of dynamic multi-cell battery systems. This design provides for complete rapid shutdown of power while minimizing parasitic corrosion and production of dangerous hydrogen gas. The disclosure also provides for the rapid restart to full power and production of constant power output throughout the consumption of the metal anode. In one embodiment, the metal air battery is enhanced by a homeostatic Machine Learning (“ML”) subsystem.

An embodiment of the disclosed air battery provides for a low-cost metal anode configuration that does not need high integrity edge seals and that can control its power output by partial submergence of the anode disc surface in electrolyte greatly simplifying designs for specific applications.

In a first embodiment, a method for operating a metal air battery is provided. The method comprising: monitoring output voltage at an electrical output of a metal air battery, the metal air battery comprising: an array of cells, each cell comprising a first electrode and a second electrode, wherein the first electrode and the second electrode are selected from an anode and a cathode; an electrolyte controller configured to provide electrolyte to each cell in the array of cells at an idiosyncratic flow rate and an idiosyncratic electrolyte level for each cell; a disk drive motor controller configured to rotate each first electrode in the array of cells at an idiosyncratic rotation rate; altering at least one operational parameter for at least one cell, but fewer than all cells, in the array of cells based on the monitoring, wherein the operational parameter is selected from a group consisting of the idiosyncratic flow rate, the idiosyncratic rotation rate, the idiosyncratic electrolyte level and combinations thereof.

In a second embodiment, a method for operating a metal air battery is provided. The method comprising: monitoring output voltage at an electrical output of a metal air battery, the metal air battery comprising: an array of cells, each cell comprising a first electrode and a second electrode, wherein the first electrode and the second electrode are selected from an anode and a cathode; an electrolyte controller configured to provide electrolyte to each cell in the array of cells at an idiosyncratic flow rate and an idiosyncratic electrolyte level for each cell; a disk drive motor controller configured to rotate each first electrode in the array of cells at an idiosyncratic rotation rate; a cell load module (CLM) disposed between the array of cells and the electrical output configured to vary resistive load applied to each cell in the array of cells at an idiosyncratic resistive load; altering at least one operational parameter for at least one cell, but fewer than all cells, in the array of cells based on the monitoring, wherein the operational parameter is selected from a group consisting of the idiosyncratic flow rate, the idiosyncratic rotation rate, the idiosyncratic electrolyte level, the idiosyncratic resistive load and combinations thereof.

In a third embodiment, a method for operating a metal air battery is provided. The method comprising: monitoring output voltage at an electrical output of a metal air battery, the metal air battery comprising: an array of cells, each cell comprising a first electrode and a second electrode, wherein the first electrode and the second electrode are selected from an anode and a cathode; an electrolyte controller configured to provide electrolyte to each cell in the array of cells at an idiosyncratic flow rate and an idiosyncratic electrolyte level for each cell; a disk drive motor controller configured to rotate each first electrode in the array of cells at an idiosyncratic rotation rate; a cell load module (CLM) disposed between the array of cells and the electrical output configured to vary resistive load applied to each cell in the array of cells at an idiosyncratic resistive load; a boost control module (BCM) disposed between the array of cells and the electrical output configured to boost the voltage of each cell in the plurality array of cells at an idiosyncratic boost control level; altering at least one operational parameter for at least one cell; but fewer than all cells, in the array of cells based on the monitoring, wherein the operational parameter is selected from a group consisting of the idiosyncratic flow rate, the idiosyncratic rotation rate, the idiosyncratic electrolyte level, the idiosyncratic resistive load, the idiosyncratic boost control level and combinations thereof.

In a fourth embodiment, a metal air battery comprising: an array of cells, each cell comprising a first electrode and a second electrode one of which rotates relative to the other, wherein the first electrode and the second electrode are selected from an anode and a cathode; an electrolyte controller configured to provide electrolyte to each cell in the array of cells at an idiosyncratic flow rate and an idiosyncratic electrolyte level for each cell; and a disk drive motor controller configured to rotate each first electrode in the array of cells at an idiosyncratic rotation rate.

This brief description of the invention is intended only to provide a brief overview of subject matter disclosed herein according to one or more illustrative embodiments and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however that the drawings illustrate only certain embodiments of this invention and are therefore not be considered limiting of its scope, for the scope of the invention encompasses other equally effective embodiments. The drawings are not necessary to scale, emphasis generally being placed upon illustrating the features of certain embodiments of the invention. In the drawings, like numerals are used to indicate like parts throughout the various views. Thus, for further understanding of the invention reference can be made to the following detailed descriptions read in conjunction with the drawings in which:

FIG. 1 is a schematic depiction of the components of an embodiment of a dynamic multi-cell air battery;

FIG. 2 is a schematic of a metal air battery with its control paths;

FIG. 3 is an example of an IV plot of a dynamic aluminum air cell with variable load;

FIG. 4A is an example of a Cell Load Management schematic;

FIG. 4B is an example of a Boost/Buck Converter schematic;

FIG. 5A is an example of the disc speed state as an operational parameter;

FIG. 5B is the depiction of the electrolyte flow/level as an operational parameter;

FIG. 5C is an example of the cell load management as an operational parameter;

FIG. 5D is an example of the Boost Control Module as an operational parameter aggregating the cell power;

FIG. 6 is an example of boost control efficiency for various loads;

FIG. 7 is an example of three operating modes using four operational parameters to deliver a given load requirement;

FIG. 8 is an example of the aluminum-oxygen multi-cell system schematic;

FIG. 9 is an example of the components of an immersed design cell;

FIG. 10 is a view of a part of a dynamic single cell design, including those of an immersed design cell;

FIG. 11 is a view of a cell array for an immersed dynamic multi-cell design;

FIG. 12 is a possible view of a cathode element from a cell for an immersed dynamic multi-cell design;

FIG. 13 is a view of the cathode assembly array in a housing for an immersed dynamic multi-cell design;

FIG. 14 is a cross sectional view of an embodiment of the immersed dynamic multi-cell metal air battery design;

FIG. 15 depicts a battery control system;

FIG. 16 is an overview of a battery control system that includes the battery;

FIG. 17 is an example of a thermoelectric generator (TEG);

FIG. 18 is an example of a data store; and

FIG. 19 is an example of a super cap with its charge controller.

### DETAILED DESCRIPTION OF THE INVENTION

A number of attempts have been made to resolve the aforementioned problems which can be divided into static systems using static anodes and cathodes (typically plates of metal that are stationary relative to the cathodes) and dynamic systems, using anodes and cathodes that move dynamically relative to each other.

In static systems (defined as metal air batteries in which the anode and cathode are fixed relative to each other); much work has been done to control the battery system via temperature, electrolyte flow rates and composition, in combination with battery sensor outputs such as energy utilization, corrosion rates, and demand signals such as current draw and power requirements. These have shown some promise but still required significant time to reload metal anodes, usually by disassembling the battery or swapping a large battery system at a depot. They also suffer from lower efficiency as the temperature of the system is altered to control the battery operation on stop and restart cycles. Additionally, with these systems, there has been much research into the chemistry of electrolyte additives that can inhibit the production of hydrogen gas during operation and when in open circuit. This research has met with limited success. Some removable electrode designs have been tested that incorporate protection of the edges of the anode from corrosion and gas production with also limited success. Other designs have attempted to mount the anode on a moving apparatus to reduce the increase in resistance due to increase in space between the electrode and cathode. These have shown to be mechanically complicated and limit the ability to load the battery with fresh metal anodes quickly.

For dynamic systems the subject of this disclosure, (defined as metal air batteries in which the anode and cathode move relative to each other) electrolyte can be withdrawn from between the anode and cathode, slowing down the reaction and allowing some level of restart capability. One solution makes use of foam material to soak up electrolyte. Another alternative discussed more thoroughly herein, uses a “spin dry” cycle to dry the anode thereby stopping the reaction to ensure full power start up. At start up, these dynamic systems also benefit from a “milling effect”, whereby the surface of the anode can be swept clean of any imperfection or “gel” from the buildup of unwelcome local chemical reactions.

The aforementioned “foam” solution requires a small electrolyte chamber distinct from the other cell components, limiting electrolyte flow and energy and power output. Recharge, in turn, requires the disassembly of each cell to reload metal anodes. The “spin dry” solution works well for many applications and benefits from a quick slide in to recharge for one or more anodes. For applications requiring higher power it is advantageous to use both sides of the anode disc however these systems can become quite complicated based on prior art designs especially if high power needs are intermittent.

As metal air batteries are considered to fulfill the broad range of requirements currently met by internal combustion engines, a simple control system is required that can meet the broad range of performance and efficiency needs, while addressing the unique operating characteristics and opportunities presented by dynamic metal air batteries. Normally, batteries such as lithium ion, do not have the ability to turn off cells when not needed and are not active (meaning sensing requirements and then changing to meet) or adaptive (improving over time say with Machine Learning). For strict electro-chemical batteries such as lithium ion, the battery is essentially in an always on state. If this control system was used for metal air batteries, significant anode material (energy) would go to waste. Again, a novel, simple control system is required that meets the broad range of performance needs efficiently.

The present disclosure pertains to a control system for a dynamic adaptive multi-cell metal air battery that leverages the mechanical advantages of a dynamic system to provide variable current load requirements, while concurrently utilizing a broad range of subsystem controls to optimize battery operation.

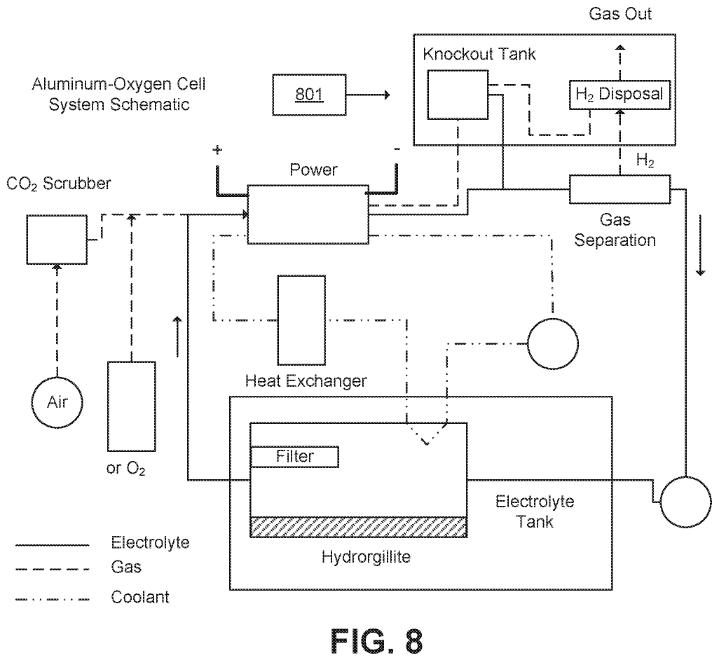

The present disclosure pertains to a metal air battery with its control system that provides for complete, rapid shutdown of power without parasitic corrosion and production of dangerous hydrogen gas as described above. This disclosure also provides for a rapid restart to full power and production of constant power Output through the consumption of the metal anode. Some embodiments of the disclosed air battery, as shown in FIG. 9, provide for a low-cost metal anode configuration that does not need high integrity edge seals (identified as the “immersed design”) and that can be automatically loaded into the metal air battery system for the purposes of extended operation. It also discloses the use of both sides of the anode for maximum output power. In one embodiment, the present disclosure also outlines a homeostatic Machine Learning (ML) system to improve the effectiveness and efficiency of dynamic, adaptive multi-cell metal air battery systems.

Effectiveness is largely determined by a power system's ability to meet the current load requirements at a given voltage, be it, DC or AC electrical requirements. The output of metal air batteries is direct current (DC) electrical potential which, in turn, can be converted to alternating current (AC) with existing technologies (e.g., inverters) if desired. In a multi-cell metal air battery system, there are numerous degrees of freedom to ensure a high degree of effectiveness, as long as power requirements do not exceed the maximum power output of the multi-cell battery. Cell outputs can vary significantly due to numerous factors including the resistive load applied to each cell, chemical makeup of the fuel (metal anode and alloying elements), the state of the electrolyte, typically potassium hydroxide or sodium hydroxide, the temperature of the electrolyte, variations in air/oxygen, electrolyte, and/or current flows, cathode chemistry, cell or cathode construction, and/or process variations to name a few. However, a major advantage of a dynamic system, whereby one electrode (e.g., the anode) rotates relative to the other electrode (e.g., the cathode), is that local imperfections are averaged over a whole scanning range at the disk level, and mass transfer between the cathode and anode through the electrolyte is enhanced. Surprisingly, this in turn provides a large operating range for each cell, allowing a broad range of reasonably efficient outputs at various voltage and current levels. This further simplifies the control parameters significantly to four primary control factors: disk speed, electrolyte level or flow, Boost Control logic, and Cell Load Management further enhanced through the ML algorithmic monitoring and control to maintain homeostatic steady state.

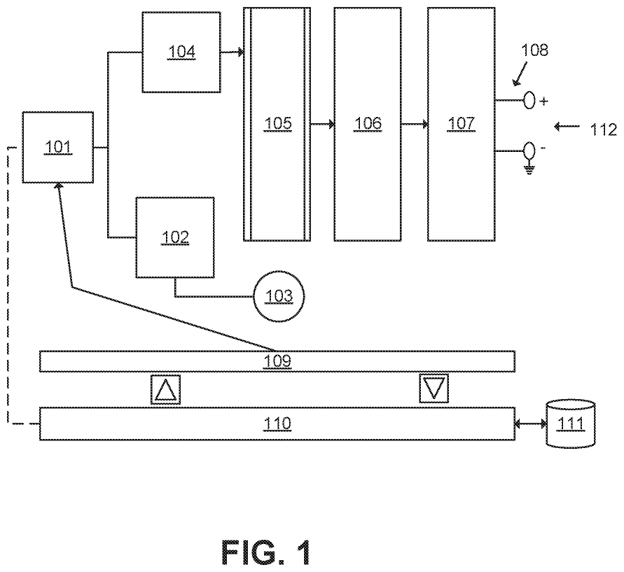

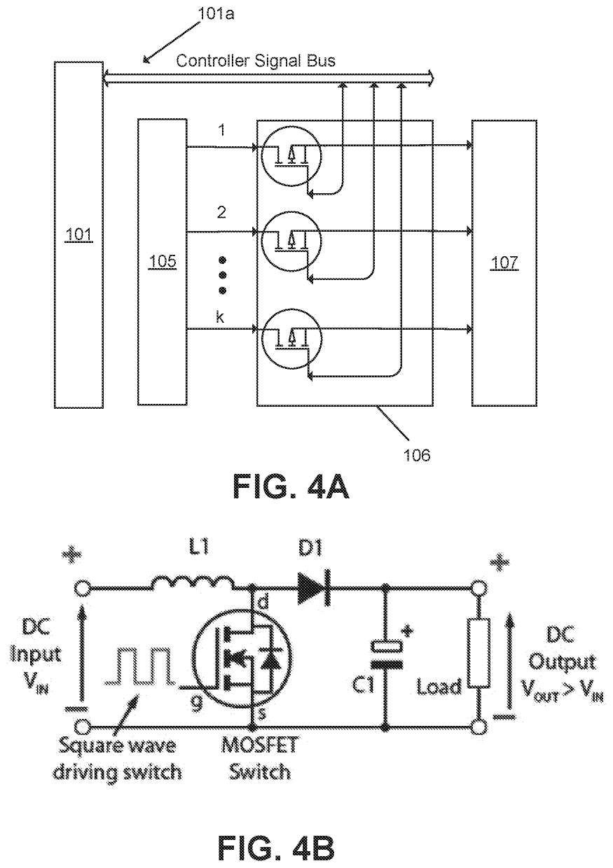

FIG. 1 depicts a system 100 for providing electrical power. The system 100 comprises a controller 101 that is configured to operate a disk drive motor controller 102 and an electrolyte controller 104. The electrolyte controller 104 provides electrolyte to an array of cells 105 that has a total of k metal air cells. Each metal air cell is collectively (immersed design) or independently (sealed design) connected to the electrolyte controller 104 and an oxygen supply loop (not shown). Electricity from each metal air cell is provided to a Cell Load Management Module (CLM) 106 which, in turn, provides electricity to a Boost Control Module (BCM) 107 and thereafter sends an output voltage 112 to an electrical output 108. As shown in FIG. 4A, the CLM 106 aggregates the power from a multiplicity of cells from the array of cells 105 to feed the BCM 107. The CLM 106 has built- such as a diode gating system or MOS FETS-prevent the reverse flow of power from active to inactive cells and also to gate the flow of electricity from the cells to the BCM 107.

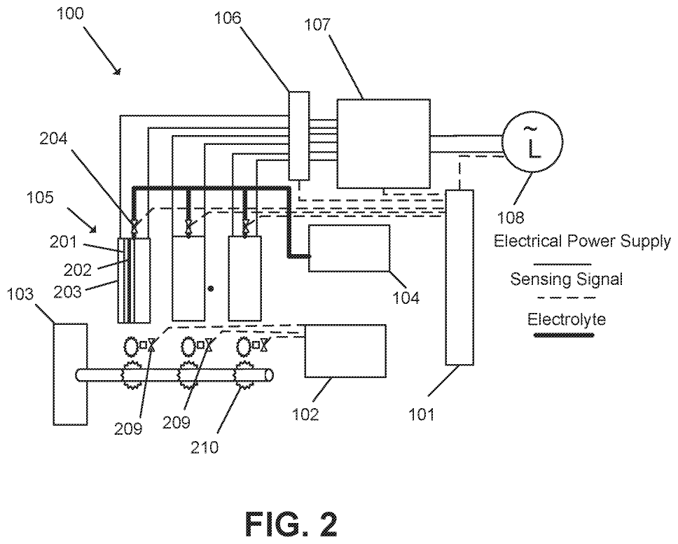

The CLM 106 can also gate the cell outputs to work in parallel to deliver higher amperage or in series to deliver higher voltage to the BCM 107 as is required by the load through a bank of electronic switches that may be controlled by the controller 101 (not shown for clarity). The controller 101 signals and controls the CLM 106 via a controller signal bus 101a. The controller 101 enables, disables, or modulates the gating and logic elements in the CLM 106 through the bus 101a. The bus 101a is one of more pathways for control signals to travel in either serial or parallel formats. The controller 101 can thus individually or in parallel control the flow of electricity through the MOS FETS (as depicted in FIG. 4A) by providing an appropriate voltage level to the gate of the MOS FET allowing electricity to flow from the MOS FETs source to drain and thus to the BCM 107. The controller 101 coordinates the activating of a cell in the array of cells 105 in conjunction with the gating signal so that the electricity produced would not be dissipated as heat or otherwise wasted. The activation of the cell is performed by controlling valves 204 in FIG. 2. to control the flow of electrolyte.

As used in this specification the term “Boost Control Module” (i.e., BCM 107) refers to any one of (1) Buck Converters (2) Boost Converters and (3) Buck-Boost Converters with their associated circuitry (FIG. 4B). The disk drive motor controller 102 operates one or more motors 103 which, in turn, operate one or more drive shafts (not shown) that rotationally drive either the anode or the cathode of the metal air cells within the array of cells 105. In one embodiment, controller 101 controls the disk drive motor controller 102 and the electrolyte controller 104. The controller 101 also provides instructions to the CLM 106 and the BCM 107. The controller 101 receives information from sensor array 109 which monitors the current load, the electrolyte flow rate, electrolyte levels, operational temperature, and speed of rotation of each individual cell anode. The sensor array 109 also monitors the voltage and wattage at electrical output 108. In another embodiment, a machine learning (ML) controller 110 provides instructions to controller 101 and thus controls the disk drive motor controller 102 and the electrolyte controller 104. The ML controller 110 also provides instructions to the CLM 106 and the BCM 107. A data storage unit 111 provides the ML controller 110 with stored parameters and well as enables the recording of new data from the ML controller 110. In one embodiment, the stored parameters are transmitted (e.g. wirelessly) to a remote data processing center. For example, a metal air battery in an automobile may transmit stored parameters to a remote data processing center in a garage. The stored data may be transmitted to another remote data processing center through the internet for subsequent processing. The ML controller 110 receives information from the sensor array 109 which monitors the electrical output of each cell, the electrolyte flow rate, operational temperature, and speed of rotation of each cell anode. Thus, the sensor array 109 comprises an electrical output sensor, an electrolyte flow rate sensor, a temperature sensor and a rate of rotation sensor as well as liquid (electrolyte) levels sensors. In one embodiment, data is leveraged from cloud storage from other systems, current and expected environmental factors to enhance the throughput of the battery from the learned experience data from other batteries. Also, through cloud connectivity predictive maintenance and data logging is enabled.

In some embodiments, the electrolyte is “sealed” from contacting the edges of the anode so that localized corrosion and pitting can be avoided. Examples of “sealed designs” are disclosed in PCT/IB2018/001264 and GB2538076 and can be utilized in conjunction with the disclosed system. Both disclosures are representative of a “sealed design” since the edges of the discs are sealed to reduce detrimental edge effects due to corrosion, with the added feature that the drive unit for each element rotated (anode, cathode or both) is independently controllable, or in another embodiment, at least two cells can be independently controllable. These designs also benefit from the ability to control electrolyte flow by cell.

FIG. 2 shows a design to allow the independent rotational control of a rotating metal electrode 201, such as an anode, within a metal air battery 203. The metal air battery 203 also has a second electrode 202, such as a cathode. The controller 101 controls all the array of cells 105 and the valves 204 through the electrolyte controller 104 and thus the flow of electrolyte from its storage to the array of cells 105. The controller 101 also controls the CLM 106. The disc drive motor controller 102. controls a main shaft motor and ancillary drives 210. In another embodiment, the single drive shaft column includes at least two drives, one drive for the slow RPM, another drive for the spin dry cycle with similar actuators. In another embodiment, two ancillary drives 210 are used per disc, one for the discharge rotational speed, and another for the “spin dry cycle”. In yet another embodiment, the controller 101 also controls the disc drive motor controller 102 to provide independent and, where required, different rotational speeds to the rotating electrode array by means of gears or electronic speed controls as in the instance of a “spin dry cycle”. In other embodiments, a liquid or air turbine drives each electrode individually instead of a mechanical gear to a drive shaft. A hybrid liquid hydrodynamic and hydrostatic bearing combination system supports the entire electrode to ensure low friction, and to allow the pressurized gas or fluid to efficiently drive disc rotational speed. The BCM 107 controls the flow of power to the electrical output 108 receiving the input from the array of cells 105 through the CLM 106.

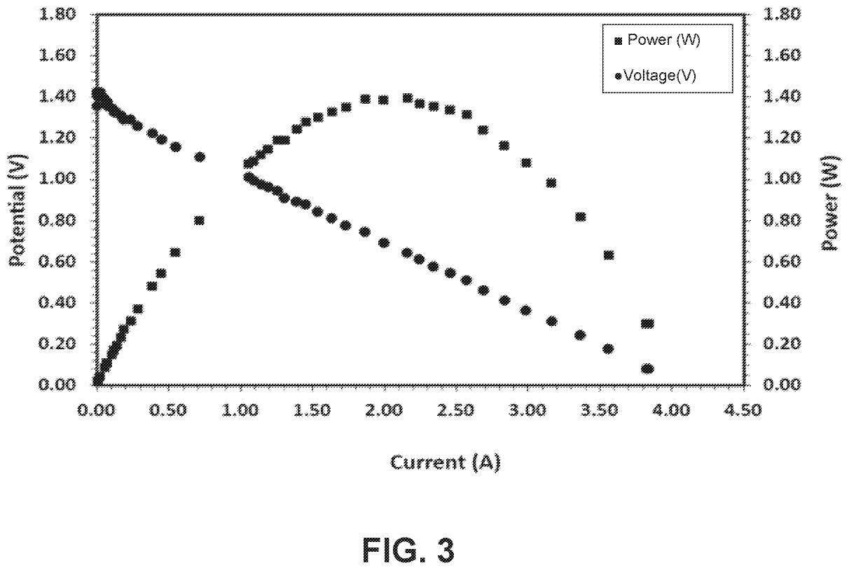

FIG. 3, shows a Voltage Current plot using a range of resistive loads for one dynamic Al-air cell. Note the very large range of voltages (V) and currents (I) that can be selected while still maintaining a relatively high-power output. In the example shown, peak power of approximately 1.4 watts occurs at a realized cell voltage of approximately 0.7 volts, and 2.1 amps. However, 90% or more of the maximum power can be realized between realized cell voltages of 0.9 down to 0.5 volts respectively with currents of 1.3 amps to 2.5 amps. This wide, relatively efficient, operating range coupled with the ability to turn cells on and off quickly, allows the battery system to choose between multiple operating modes while ensuring that output load requirements are met. A controller (see controller 101 in FIG. 1 and in FIG. 2) selects the apparent resistive load “shown” to each cell via the CLM 106 to ensure that overall load requirements are met, while operating most effectively and efficiently.

FIG. 4B depicts one embodiment of the BCM 107 (specifically a Boost/Buck Converter). One of ordinary skill in the art, after benefitting from reading this specification, could design a similar BCM using the same principle. This circuit design allows for the voltage output of the cell to be stepped up or down, depending on the control signal sent from the controller to achieve both the effectiveness and efficiency objectives as described herein. In one embodiment, the controller 101 sends multiple different signals to different cells to ensure that each cell or group of cells achieves the desired target power as needed by the load. In another embodiment, these signals are sent from the ML controller 110 in FIG. 1.

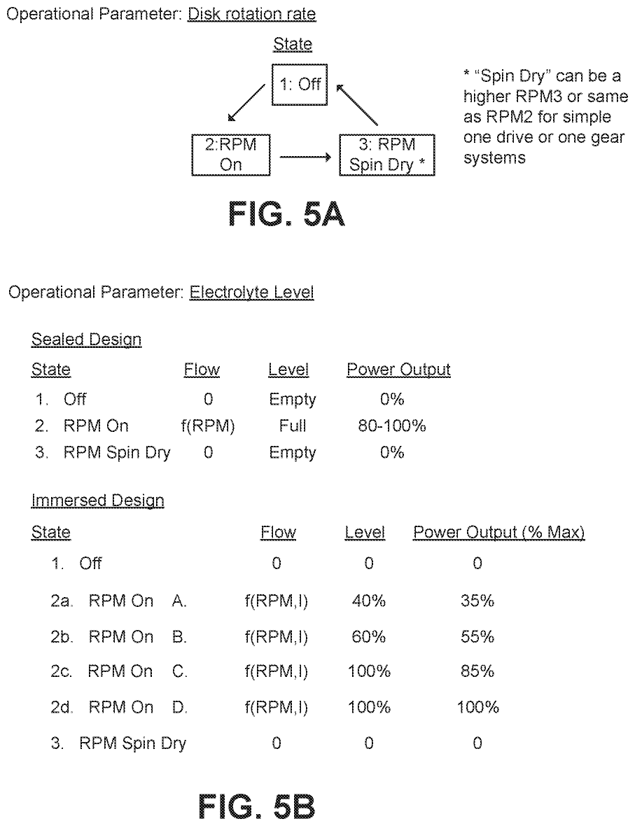

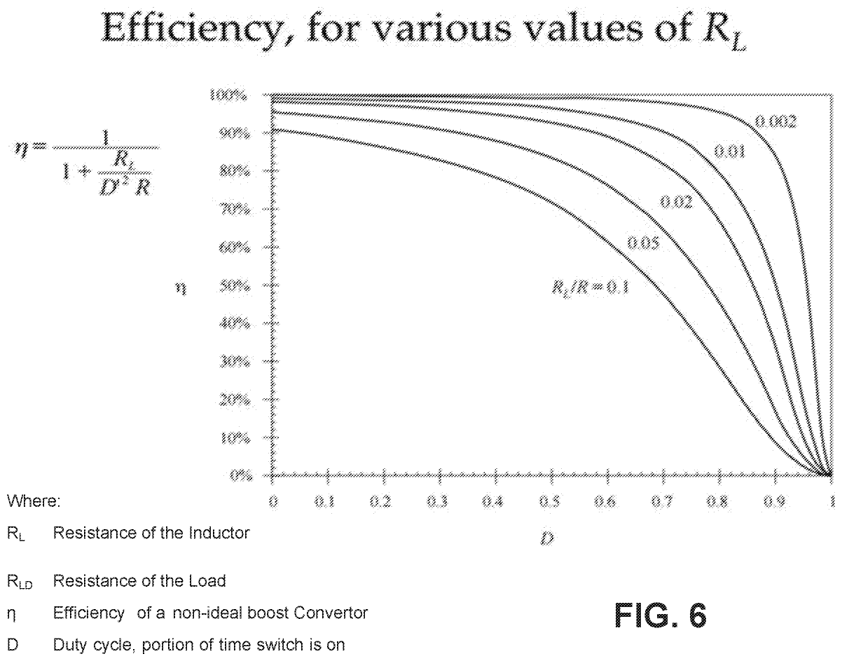

As shown in FIG. 1, both the controller 101 and the ML controller 110 have a wide range of inputs through the sensor array 109, including current load input and voltage input and hence power demand. In turn, these controllers have logic to meet the effectiveness requirements demanded of the energy source (using current and voltage sensors), primarily the current load required, while matching voltage needs, but with potential other factors including, for example, power range of demand required (or power demand variation), time to expected change in load, or expected fuel longevity. Further, the controllers enables cells on demand or by algorithm to do “wear levelling” thus increasing the life of the anodes and delivering power when required. The operational parameters utilized to match the demand signal include four elements as described in FIGS. 5A, 5B, 5C and 5D, (1) idiosyncratic rotation rate of each disk (e.g., disk speed output), (2) idiosyncratic electrolyte level for each cell (e.g. electrolyte flow/level output, (3) idiosyncratic resistive load of each cell (e.g. CLM selection output) and (4) idiosyncratic boost control level (e.g. BCM selection output). These four operational parameters are concurrently managed to supply the desired demand, taking into account potential secondary factors depending on application. A sample of the logic to control using these four elements, is described in FIG. 7 and disclosed herein.

As shown in FIG. 5A, one of the advantages of a dynamic multi-cell battery is the ability to turn cells on or off, and potentially to also alter their output based on disk rotation speed (RPM, rotations per minute). Either the anode (metal) or cathode (air breathing) can rotate.

The first operational parameter is idiosyncratic rotation rate of each disk. In one embodiment, the anode disk is rotated because this allows a spin dry cycle to completely stop the reaction quickly, facilitates quicker fuel change, and achieves better mass transfer, improving efficiency. The cell begins in the off, no rotation state FIG. 5A. State 2 is some rotational speed typically between 10 and 200 RPM and depending on the system this can be a fixed speed, or for more complex systems a variable “low” speed to generate required power output. This speed can be changed to tune the cell output with rotational speed. When the controller 101 determines that a cell should be turned off, electrolyte is first removed from the cell, and State 3 is entered to dry the anode, either at the same speed for a simple system, or with an increased rotational speed (e.g. at least 10 revolutions per minute, between 10 and 4000 RPM, at least 1000 revolutions per minute, etc.) if a quick stop is required. When dry the cell re-enters State 1—namely Off.

The second operational parameter, as shown in FIG. 5B, is the idiosyncratic electrolyte level for each cell. There are at least two types of dynamic designs, the sealed designs (see, for example, PCT/IB2018/001264 and GB2538076) or the immersed design, disclosed herein. For the sealed design the states are linked to those related to disk speed as shown in FIG. 5B. Flow is a function of the rotational speed of the disk, optimized to create the most efficient energy output. In these designs a pump provides the electrolyte flow such that the whole surface of the anode is covered when in the “On” state. Valves 204 are opened or shut to either provide electrolyte or drain it completely in the “Off” state. In the immersed design, rotational speed and electrolyte level have a larger impact on output energy for the cells. Specifically, to run at the highest power output, all the cells would be fully immersed and electrolyte flow would be optimized for this State (State 2ₘₐₓ). However, if less power is required, both flow and fluid levels can be reduced to achieve the desired output again using a combination of pumps for electrolyte flow, and valves to control electrolyte levels. This design is particularly useful when intermittent high power is required, for example to accelerate an electric vehicle, or take off in aviation since the immersed design facilitates many, thin, and large disks for maximum power needs.

The third operational parameter is idiosyncratic resistive load of each cell, as controlled by the CLM 106. FIG. 5C shows three potential cell outputs using the cell data from FIG. 3. In the simplest design, the full load is “shown” to the multi-cell battery in a series connection. However, this simple system is often not the best option to achieve multiple objectives such as to minimize energy losses, prolong fuel supply, or potentially conserve reserve power. Also, the output of the multi-cell battery can change significantly due to environmental factors, such as temperature, air pressure, humidity, gravitational forces to name a few. The controller 101 and CLM 106 allow the system to vary the resistive load that each cell “sees”, in essence forcing the cell to a certain operating mode, or a specific position on the IV plot as shown in FIG. 3. In this manner, each cell in the array of cells 105 is controlled in an idiosyncratic fashion. The state shown in FIG. 5C shows three cells all running at different points on the IV plot but all within 10% of the peak power output for each cell at that specific time. And these cell voltages then become subject to the fourth operational parameter, the boost control logic via the BCM 107 in FIG. 1.

The fourth operational parameter is the idiosyncratic boost control level. FIGS. 5A to 5D show the impact of the BCM 107 on a range of cell output signals for cells 1 through k. In this diagram, Vᵢ₁ is the input voltage from cell 1 after the pass through from the CUM 106, The controller 101, based on logic that is described elsewhere in this disclosure, selects a boost converted level (BCLₑ) for this cell, essentially the multiple by which the voltage will be increased, typically 1 to 12 times. The realized cell output from cell 1 then will be Vₒ₁, or the output voltage from cell 1 and is a function of the BCL₁ times Vᵢ₁. The BCM 107 can be a simple series-only connected circuit (as shown in FIG. 5D) or can allow the cell voltages to be combined in a combination of series or parallel connection, which may or may not switch over time. Collectively the BCM output produces a V_{BCM} which, in a series only design, will be the sum of the V₀ across all k cells.

As described and depicted in FIGS. 5A, 5B, 5C, 5D these four operational parameters (i.e. disc speed, electrolyte flow and level, CLM, BCM) of control provide multiple options to satisfy a wide range of effectiveness goals, which usually includes load requirements in terms of output voltage, and current load, and may also include the ability to provide reserve power if required, and also efficiency goals, usually to minimize energy loss, although this may include other goals such as longevity or “wear control” (providing energy for longest time possible). Since an important efficiency goal is to minimize energy losses in the system, while meeting an important effectiveness goal (to meet load requirements), energy or power losses are evaluated for a reasonable range of operating parameters. Excluding any losses related to an inverter that may be downstream from the output to convert to AC power, these energy losses (Eₑ) can be grouped into three groups, cell level, system level, and BCM level.

Cell level losses: For Al-air batteries cell level losses include parasitic or undesired reactions including premature corrosion of the aluminum anode resulting in hydrogen evolution, the formation of an oxide layer on the aluminum anode leading to an increase in the resistance of the cell, and impacts of aluminum hydroxide saturation in the electrolyte, lowering its conductivity. With a dynamic, self-adaptive battery, an understanding of the effective for each cell, provides the inputs required to determine an optimal operation for the ML system as discussed elsewhere in this disclosure. The largest losses of energy are in the form of heat, typically about 50% of the available energy in the aluminum. Losses associated with oxygen are ignored given that the supply is widely available with immaterial cost. Note that in most applications this heat is exhausted to the environment, however in some applications heat is utilized. For example, this heat can be used to maintain a package temperature in an extremely cold environment, or in an automotive application to keep the cabin warm. The heat may be converted to electricity using semiconductor thermoelectric generator device 1700 components to be fed back to the BCM for improved output and efficiency.

For the purposes of this disclosure, we consider the effective energy or power efficiency when compared with the actual peak power and/or peak energy available from a cell at the best possible electrolyte flow rates, and disk speeds for a given operating environment Pₚₑₐₖ₍₁₀₀₎ or Eₚₑₐₖ₍₁₀₀₎. In turn, if we think of the theoretical maximum energy from the aluminum (approximately 8.33 kwh/kg), we consider four sources of cell level energy loss, (1) structural losses, due to the inherent electrochemical reaction (2) losses primarily to heat, (3) losses relative to the ideal spin rate and flow rates for electrolyte, (4) losses due to cell loading relative to peak energy conversion.

System Losses: There are numerous subsystems that consume energy in a dynamic multi- cell metal air battery which may include (1) drive motor(s) (2) electrolyte pump(s) (3) electrolyte reconditioning system (4) hydrogen knockout system (5) CO₂ scrubber system (6) actuators and solenoids (electrolyte valves, gear actuators etc.) (7) additional pumps (if required) (8) control Electronics.

Cell level and system level energy and power losses are typically in the range of between 6-18% of total output depending on the system design, the number of cells operating, and the operating environment. These losses become a function of the system design relative to output, the number of disks spinning, and electrolyte flow rates.

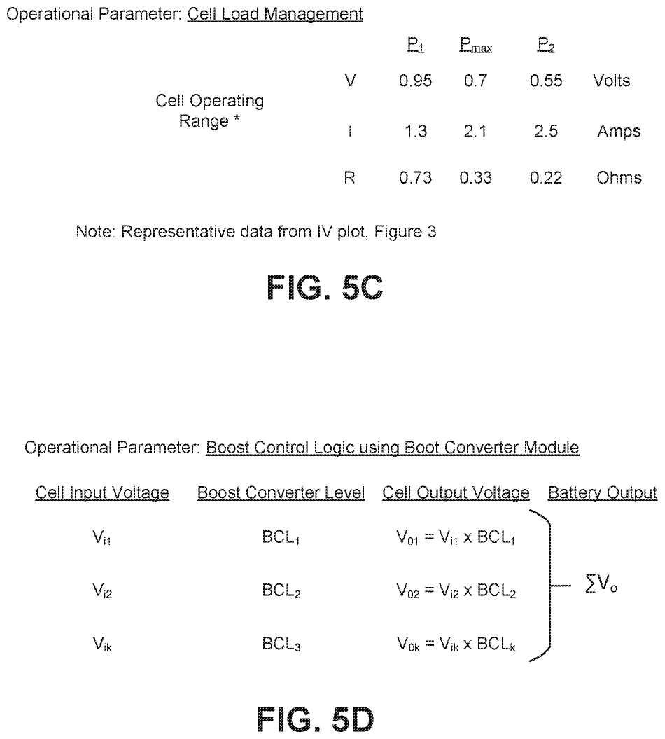

BCM level losses: The BCM logic also creates a variable energy loss, again primarily in the form of heat from resistance. These losses are largely governed by the factors as shown in FIG. 6. These losses may be mitigated by using thermal energy harvesting components like semiconductor thermal energy generators.

The three levels of energy loss (cell, system, BCM) can be estimated and stored in data storage unit 111 (FIG. 1) as operating parameters, and or sensed in real time, and or learned across a wide range of devices using Machine Learning. In turn then, the control system uses one or more of the operational parameters (i.e., disc speed, electrolyte flow and level, CLM, BCM) to optimize system behaviour achieving the required output load.

FIG. 7, shows three such scenarios or operating modes to demonstrate the potential control system logic for a four-cell aluminum air battery system with a sealed design that includes the ability to turn disks on and off (see below for a description of the “immersed design”), utilizing the representative I-V plot as shown in FIG. 3.

In FIG. 7, current draw sensors in the sensor array 109 determine the current load requirement (2.7 watts at 3 volts) that should be provided to electrical output 108. Three scenarios are shown to demonstrate the methodology and the use of logic to achieve desired results. One of ordinary skill in the art, after benefitting from reading this disclosure, would appreciate additional scenarios are possible. In scenario 1, all four cells are turned on (disks spinning at a rate that produces 95% of the maximum power output per cell, a maximum power condition shown in FIG. 3). This scenario could be categorized as the “maximum power” scenario, as the total power available would be about 5.6 watts, well above the current demand of 2.7 watts. All four disks are spinning in state “RPM2” as shown in FIG. 5A. Electrolyte flow is producing power that is 95% of the peak power output, or the peak of the inputted best fit graph, equation shown on FIG. 7 with data from FIG. 3. The CLM system has selected the “peak power” mode for all four cells, and therefore operates at 100% efficiency. The BCM 107 is active, given that the output voltage of the cells is only 2.72 volts in this operating mode, so the BCM 107 increases the voltages by a factor of 1.1 so that in a series connection, the combined voltage is 0.75 per cell, or 3 volts in total. In doing so, the BCM 107 introduces an additional efficiency loss of 5%. The system provides the required 2.7 watts but has available an additional 2.53 watts. In some applications (e.g., powering a load with periodic short-term power spikes required) this might be the most effective operating mode and the logic would select this scenario.

Scenario 2, shown in FIG. 7, describes the scenario with three cells running to meet the same load, while concurrently reducing the unutilized power. Here the system logic recognizes that creating maximum power at the cell level is not required, and instead utilizing the CLM, operates each cell at a higher output voltage, and lower current but reasonable power output (91%) since the electrical output far exceeds the available power. In turn the control logic, recognizes the need to bump up the voltage by 1.12 to achieve the required voltage output via the BCM 107. While the energy loss due to the system increases slightly as a percentage of the overall output, this operating mode reduces the unused power from 2.86 to 1.09, thus preserving “fuel,” in this case aluminum, while generating less waste heat.

Scenario 3, shown in FIG. 7, is the most efficient of the scenarios shown. Here only two disks are turned on (“RPM2” mode) and electrolyte flows only to those two cells albeit at the rate of flow that generates the highest possible power output since the output load requires maximum power. Similarly, the CLM 106 selects the highest possible power output mode. With adequate power available, the logic calls on the BCM 107 to boost the voltage by 2.2, so that the required 3 volts is supplied with minimal power loss after system energy losses.

Taken together, the four elements greatly improve applicability of a metal air battery to various applications across a wide range of voltage, power, space, reliability, and redundancy needs consistent with the logic described in FIG. 7. This solution works very well for many applications especially during the early burn in period for the metal air battery system when metal fuel composition, cathode condition and electrolyte composition are well controlled. However, over time, numerous variabilities affect the operation of each battery system, and even each battery cell. This can include variation in the composition of the metal, the electrolyte, and cathode, different wear conditions by cell or cathode, and impacts of heat on position within the cell array to name a few. While logic can be programmed into the control system to manage these conditions, surprisingly a Machine Learning (ML) system can be used with particular advantage, to reduce energy losses as conditions change. In the Machine Learning and optimizing embodiment, the controller would learn about its environment and make decisions from the data in real-time, considering both operational and environmental factors. It would further store the new data for future reference and use.

Most batteries, especially the simple ones, do not need an advanced computer controller to monitor them to maximize their efficiencies, as enumerated elsewhere in this document. However, in an embodiment, to surmount the non-linear problems that metal air batteries bring, an adaptive, dynamic system that utilizes a goal-oriented Machine Learning (ML) controller 110 is employed that, over time, learns about the batteries own individual characteristics and properties and applies them in the problem-solving process. This is used to supplement the features and properties of the existing controller 101.

Due to the problems of metal air batteries already elaborated, an embodiment with a multimodal strategy is incorporated to overcome the numerous non-linear issues of hydrogen generation, CO₂ in air intake, variable loads, anode depletion among others—in real time. With reference to FIG. 1, the strategy is implemented by a cohesive cluster of (e.g., set of computer processors working together to achieve edge computing) based which work in tandem to sense the state of the various variables (as detected by sensor array 109) and manage the homeostatic state of the system to produce the optimum values defined as guide-points (not setpoints). These guide-points are not fixed and may be changed by the algorithms and software deployed by the system itself. They track and optimize efficiencies rather than fixed values. This is based on reinforced machine learning (ML) algorithms where the system learns and trains itself continually, using trial and error (within margins) ML Algorithms (MLA) are goal driven and do not necessarily follow linear paths. The machine learns from experience and tries to capture the best possible knowledge to make accurate decisions, continually learning from the embedded sensors and history, storing its decisions and critical data in its local non-volatile data storage.

The data generated by the numerous sensors in the sensor array 109 are analyzed using multivariate analysis, multivariable calculus, multivariate differential equations, Laplace transforms and Fast Fourier Analysis, where appropriate to analyze the vast volume of data and transform that into significant information that can be used to achieve the goals.

As in this embodiment, the ML controller 110 and the controller 101 are data driven rather than using fixed programming, it would be nigh on impossible to predict the next state of the system. The constantly changing nature of the data flow derived from the sensor data and employed by the MLA form the life blood of the intelligence, which in conjunction with a specially designed distributed pre-emptive Real Time Operating System (RTOS) makes the whole system adaptive to varying and changing conditions.

In another embodiment the local data history and intelligence can be shared across multiple batteries, locally through communication channels like CAN, RS485, BLUETOOTH(®) and Wi-Fi and globally using IoT (Internet of Things) technology and through cloud connectivity, where possible. This sharing of data and ML models and strategies allows batteries to learn from each other and enables the evolution of the battery architecture in unprecedented ways.

The batteries themselves are rich in sensors shown as a sensor array 109 which are the data sources providing the data that the controller 101 and the MLA (running on the ML controller 110) need to control the many factors that manage and modulate the workflow of the system. The data garnered from the sensors are used as parameters to the MLA that steer them to achieve the desired goals. The MLA uses this data and past performance data to evaluate different action points in the life cycle of an operation. An example of these are cumulative hours running, from which the MLA can derive the state of the anodes and thus can estimate the wear and tear on them or gauge that from the drop in energy returned or a combination of all or more of these. The MLA can also be guided by operators to change strategies (such as wear levelling) and allows them to monitor and inspect various internal values and variables. This can be done locally via a GUI front panel or through connected devices such as phones or tablets via BLUETOOTH(®) and Wi-Fi and cellular connectivity will allow global management. Data may further be accumulated in Big Data banks for more sophisticated and enhanced data mining and learning. The batteries through its software can leverage other peripherals and systems like email, IFTTT, SMS and ALEXA(®)/GOOGLE HOME(®) to supply interactions and notifications. Thus, the onboard intelligence in the ML controller 110 can optimize itself in real time by adapting to the dynamic changes in the battery and providing the power desired out of it even in varying load and operating conditions. Digital potentiometers, digital to analog and analog to digital converters work hand in glove with the MLA and RTOS to control the various parts of the battery system through hardware abstraction layers and peripheral drivers.

The problems as stated before are overcome by using MLA/ML controller 110 in conjunction with the controller 101 based on the onboard intelligence which senses and controls the rotation and angular acceleration of the discs centered on the operation state of the system (start/shutdown/run) the ML controller 110 does this through slave computer processors that are optimized to do so through commands sent to the ML controller 110. The ML controller 110 controls the flow of electrolyte into each cell by means of valves 204 and 209, thus cells can be dynamically added to supply different load requirements as needed. This conserves anode material when not needed which is a key differentiator in contrast with other batteries where the anode is continually being used up. Controlling the anode rotation and the flow of electrolyte takes care of corrosion problems. Using centrifugal forces to clean the discs of electrolyte, prevents pitting and corrosion and enhances the overall life of the battery. Shutting off electrolyte to different cells yet maintaining required output state allows for intelligent anode preservation and controlled “wearing down” strategies. Cleanly starting and stopping the battery is a major challenge due to the production of dangerous hydrogen especially when the electric load is removed. The methods described above in conjunction with the use of hydrogen and load (current) sensors enables the controller 101 to programmatically control and optimize the rotation, electrolyte injection and disperse the hydrogen safely.

The energy transfer and conversion from the low battery voltage into higher voltages is performed via Buck Boost technology by the BCM 107 as shown in FIG. 4B. The onboard slave computer processors produce an adaptive and variable Pulse Width Modulation (PWM) signal to drive the Buck Boost circuitry and monitor the voltage and load current. It automatically adapts and manages the output performance overcoming parasitic resistances via commands from the ML controller 110. These slave computer processors report back sensor information to the system and can operate autonomously under the overall supervision and control of the controller 101 which invokes the MLA and the ML controller 110 and is responsible for overall operational performance.

The ML controller 110 may be implemented in a PSoC (Programmable System on a Chip) and/or in a FPGA (Field Programmable Gate Array) combination for flexibility speed, enhanced performance, and security. Further data storage unit 111 would be in FRAM (Ferroelectric Random-Access Memory) which is shock proof, requires no batteries and has an endurance of over 10¹⁴ write cycles. The MLA model data may be stored therein. Built in DMA (Direct Memory Access) channels will connect peripherals and memory for non-CPU intervention for high-speed data transfers leaving the CPU free for computation and other tasks. Using 3-axis gyroscopes and 3-axis accelerometers in addition to the other sensors, the ML controller 110 may infer movement and tilt angles to better optimize the efficiency of the system. When needed a GPS chip set can provide location data for automotive, flight and military applications. A cellular modem would allow cloud connectivity for field applications. The FPGA/PSoC has a built-in crypto unit that does encryption/decryption for communication and storage security to prevent hacking and cyber-Attacks.

A system based on the ML embodiment would start life the first-time power was turned on. The ML controller 110 would try and configure itself determining its own configuration, and the environment around it via the sensor array 109. The ML controller 110 reads its data storage unit 111, querying its “genetic” makeup and configuration if present. Else the ML controller 110 would configure itself by using data it gathered to check for the number of cells in the cell array present and the various controls and feedback loops that it could determine from its sensors. The ML controller 110 enables the CLM 106 to start the process all the while monitoring and sending controlled signals to the CLM 106 based on the load information and internal parameters and algorithmic constraints. The ML controller 110 constantly monitors for load change conditions and signal the CLM 106 to adjust its controls on the speed of the motors, number of cells to use, amount of electrolyte flow among other control points. The ML controller 110 monitors system temperature enabling fans and cooling mechanisms or routing any heat to appropriate channels possibly using the Peltier/Seebeck effects, among others to either cool the system or derive energy from the excess heat. The energy garnered is fed to the CLM 106 for efficient re-use. The ML controller 110 would be constantly learning about itself with the ultimate goal of delivering the optimum power required by the electrical output 108 through variabilities in the construction of the unit, the different types of loads, system transients and the need to maintain steady state. All the while the ML controller 110 analyzes the data and writes out parametric data to solve problems and the solutions employed to its data storage unit 111 for use in the future. As an example, the ML controller 110 could analyze a new requirement for current given that an extra load has been added to the electrical outputs 108 which would thus result in the need for more power. The ML controller 110 would inspect its database and look for existing solutions. If an optimum solution was found it would employ that one. Otherwise, the ML controller 110 would go about creating a solution by looking for inactive cells, examining their history and wear levels, computing the best set of cells to use and activating them step by step in sequence to provide the required power. This would be then recorded as a possible solution. The use of Secondary Energy Storage (SES) 1506 or supercapacitor 1604 on the outputs buffer the transients and fluctuations when power surges are required. These optimizations would increase the life of the anodes and the whole battery. If connected with other sister ML-enabled batteries and or the cloud the solutions would be shared with all systems that subscribe to the service. Also, current information could be pushed to the cloud for automatic preventative and predictive maintenance which would prevent unplanned or sudden downtime.

In addition to the control system described above relates to a high-power embodiment of a dynamic multi-cell metal air battery or immersed design that addresses at least some of the parasitic corrosion problems of conventional static and dynamic metal air battery systems. Corrosion of the edges of anode plates and parasitic corrosion of the surface changes the shape and the I²R losses (electrical resistance) due to the changing distance between the anode and cathode due to this corrosion. Mechanical loading of new metal anodes requires a high integrity edge seal on the metal anode to prevent entrapment of electrolyte after the drain of a cell electrolyte.

Metal air batteries provide high energy density power sources that show promising applications as mobile and stationary distributed power sources. They have the potential to replace the internal combustion engines found in hybrid cars and aircraft since the energy density, efficiency of conversion approach those of hydrocarbon fuels.

The anode or cathode may be allowed to adjust position and follow the corrosion of the metal anode surface which greatly reduces the I²R losses of conventional systems. However, there is no solution for inconsistency in the electric field between different areas of the anode cathode assembly. Also, conventional systems cannot provide for complete removal of electrolyte from a previously operating system.

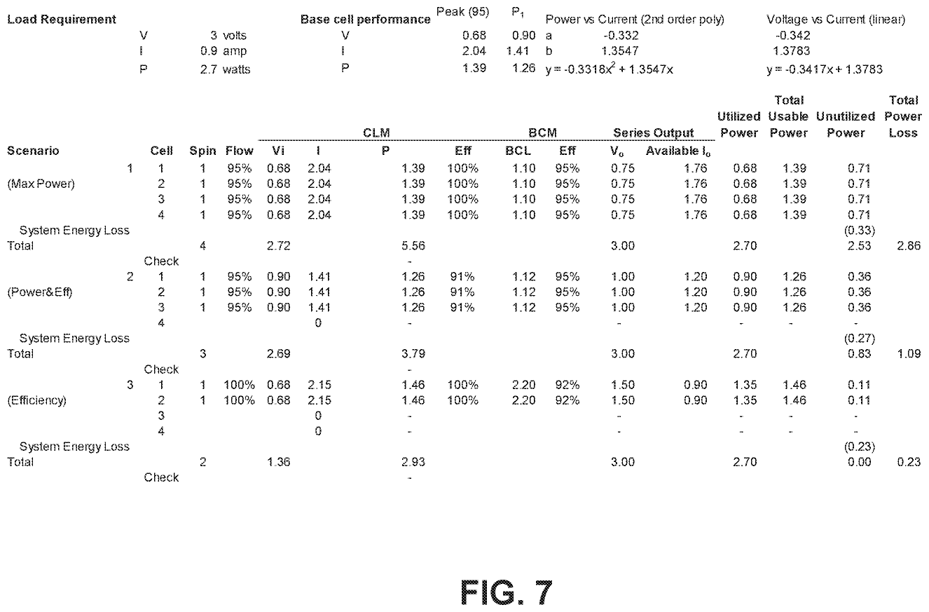

The common embodiment of a conventional metal air battery cell is shown in FIG. 9 and the usual surrounding support system in FIG. 8. In FIG. 9 the anode 903, electrolyte 901 and air breathing cathode 902 are depicted in the schematic. For any dynamic metal air battery, one of either the anode 903, or the air breathing cathode 902 spins relative to the other. While these anode and cathode are shown as disks, in another embodiment they are cones, or spherical. In another embodiment both sides of the anode 903 are used for higher power with air cathodes on either side. The air breathing cathode 902 commonly contains a conductive charge collecting screen embedded in a conductive matrix that contains a catalyst that promotes the reduction of oxygen. There is a hydrophobic layer that is porous to gas but not the liquid alkaline electrolyte. In short, the oxygen needed for the chemical reaction can penetrate the cathode but still hold the liquid in place against the surface of the anode. The anode 903 is made from a variety of metals such as zinc, magnesium, iron, and aluminum. Aluminum is the preferred metal in most applications due to low cost and density of the material in application.

The anode 903 is consumed during the operation of metal air batteries and causes some issues with performance and reliability of the system. First in a metal air battery that has an anode 903 (which may be fixed) and air breathing cathode 902, the metal air battery suffers from an increase in the resistance between the anode 903 and the air breathing cathode 902 due to the corrosion of a surface of the anode 903 away from the air breathing cathode 902. Second, the edges of the anode 903 that is not directly parallel to the air breathing cathode 902 have parasitic corrosion that also can produce hydrogen gas in the right circumstances. Some methods in protecting the edges of the anode 903 have been designed that are adequate in control of this issue but complicate the mechanical reload of metal anodes since perfect seal of the system is required due to the direct immersion of the anode 903 in the electrolyte.

When the electrical circuit in a metal air battery is interrupted (turned off) the electrolyte 901 reacts instantly with the metal to produce dangerous volumes of hydrogen gas that must be vented from the battery system. The hydrogen bubbles collect in the electrolyte 901 rapidly and increase the electrical resistance of the battery so that even if the battery is quickly turned back on, full power is not available until the electrolyte with hydrogen bubbles is flushed from the system. As seen in FIG. 8, this pumping and flushing of the electrolyte requires a “knockout” system 801 that separates gas and liquid so hydrogen gas can be safely removed from the system. Knockout system 801 normally uses a cascade of liquid through baffles to allow for departure of gas out of solution. Attempts to drain the electrolyte out of a metal air battery does shut down the power output but has been found to result in small droplets and liquid film coatings of the anode 903 that produce large amounts of hydrogen gas and corrode the anode 903 unevenly producing pits and voids that reduce the efficiency and amount of power available from the system. As a result of these problems, conventional metal air batteries are designed to be turned on and run until the anode 903 is spent. In summary it is exceedingly difficult to turn off a metal air battery and then turn it on again without damage to the complete system, so they are left on for the lifetime of the anode.

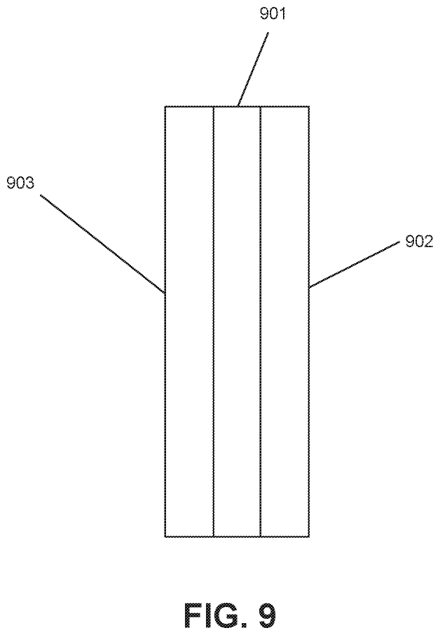

The novel anode-cathode configuration of the disclosed metal air battery and its dynamic operation provide solutions to many conventional problems. The battery can use a variety of metal anodes such as zinc, lithium, iron etc. In one embodiment, the metal used is aluminum due to low cost, weight, and easy availability with low environmental impact in production and storage. In one embodiment, reference FIG. 10, the battery comprises one circular disc 1002 of aluminum with a hole at the center 1001 about 15% the diameter of the circular disc 1002 and bonded to a non-conductive (e.g. plastic) shaft segment about 20% of the diameter of the circular disc 1002. The center 1001 of the circular disc 1002 protrudes into the shaft segment where a wire conductor is attached to the inside rim of the center 1001 so that power can be transferred to the outside of the spinning shaft as shown in FIG. 10.

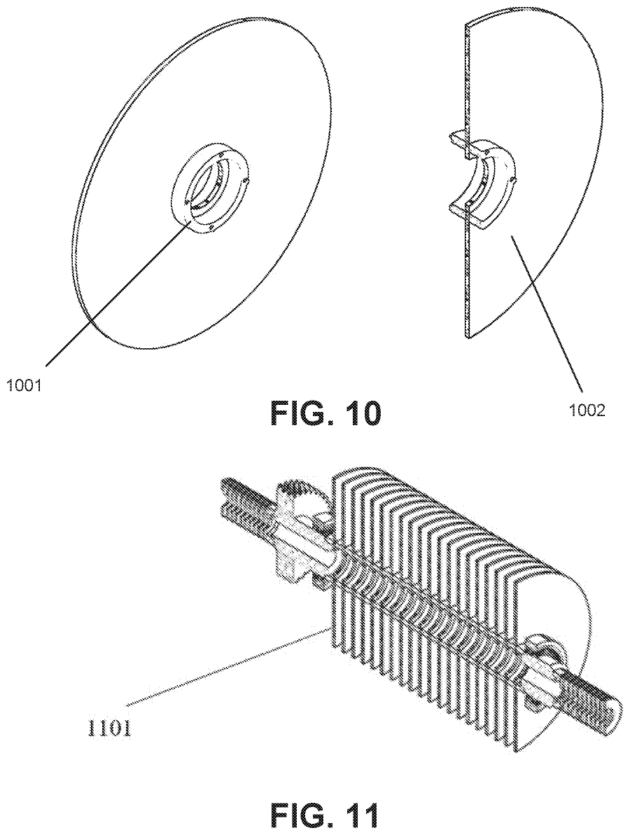

In one embodiment, the circular discs 1002 are glued to each other with separating segments to form one single sealed shaft of about 2 to 3 discs to form a plurality of discs 1101. In another embodiment, there are 20 to 22 discs long as shown in FIG. 11. In one embodiment, the circular discs 1002 are double sided such that galvanic corrosion occurs on both sides during operation. The circular discs 1002 are spaced from adjacent electrodes by a distance of between 0.5 mm and 4 mm. An individual wire is attached to each circular disc 1002 and transmits the electric circuit for each circular disc 1002 to a brush system at the end of the circular disc 1002. The disc shaft system has two sealed bearings mounted at each end of the shaft, with one end having a drive gear that meshes with a motor to turn the shaft and both ends having slip rings and brushes to connect power from each individual circular disc 1002 to the cathodes.

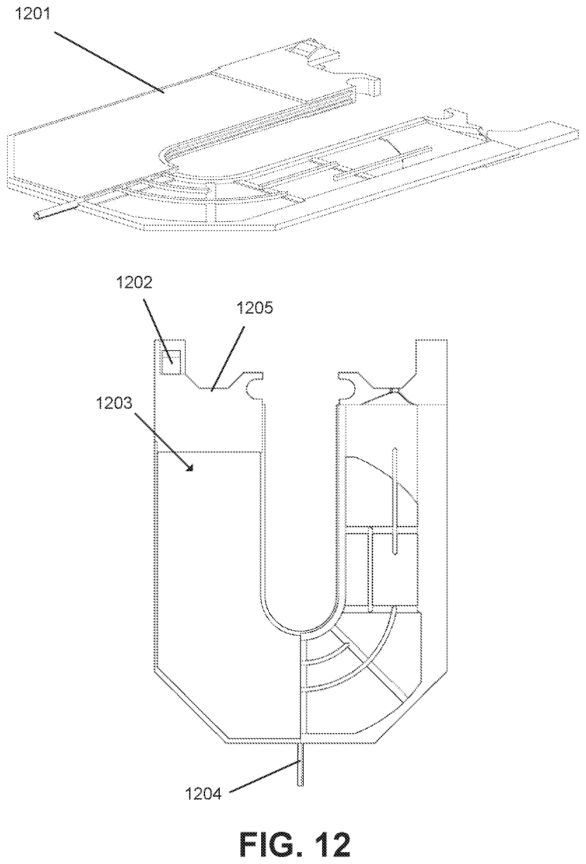

The cathodes 1202 shown in FIG. 12 have surfaces comprising a carbon or graphene based powder with hydrophobic binder and catalyst material(s) that provides for rapid Oxygen Reduction Reaction (ORR). In one embodiment, the cathodes 1202 are U-shaped and have an electrode surface 1203. The electrode surface 1203 is bonded to a metal screen with holes that allow the oxygen in the air to permeate the electrode surface 1203 for the ORR. The cathodes 1202 are double sided with electrodes on either side of a cathode box assembly 1201. In one embodiment, the cathode box assembly 1201 is U-shaped. At the center of the cathode 1202 is enough space so that a disc shaft segment can rotate freely and not touch side walls of the cathode 1202. The center of the cathode 1202 is filled with a spacer that keeps the electrolyte separated between each cathode 1202. The spacer can have disc cleaning surfaces or additional cathode materials depending on the application. On each side of the cathode 1202 and running up and down in the vertical are copper conductors that touch a cathode charge collector mesh and transmit the current to a power output 1204 located at a top of each side of the cathode 1202.

The cathode 1202 shown in FIG. 12 has an interior air space sealed tight to keep electrolyte out of the interior air space. On the top on each side is an air inlet 1205 with an air outlet 1204 at the bottom of the cathode 1202. A fan or air pump can move air in and out of the interior air space to provide oxygen to the back surface of the cathode 1202. The cathodes 1202 are mounted opposite sides of an interior air space and are on different parts of the circuit and do not electrically connect with each other. The electrode material is supported on metal screens with holes to provide areas for oxygen exchange. At the center of each cathode 1202 is a cell separator segment that can contain a disc cleaning surface or cathode material depending on the application.

The cathode electrode materials are manufactured from a carbon matrix with embedded metal wire and catalyst materials. Other cathode materials well known to those skilled in the art can be applied in the manufacture of the electrode surfaces.

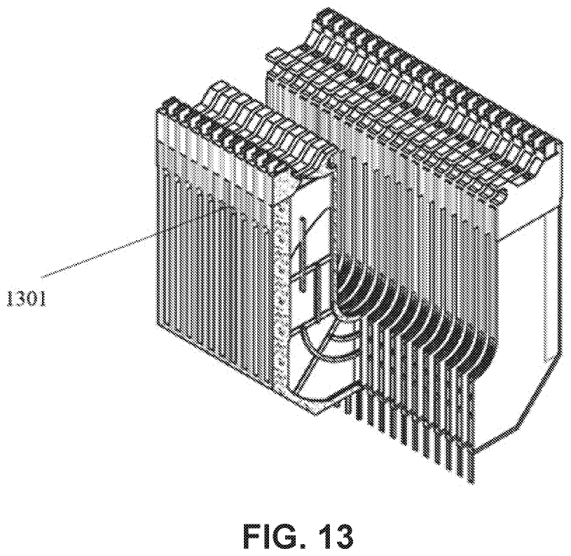

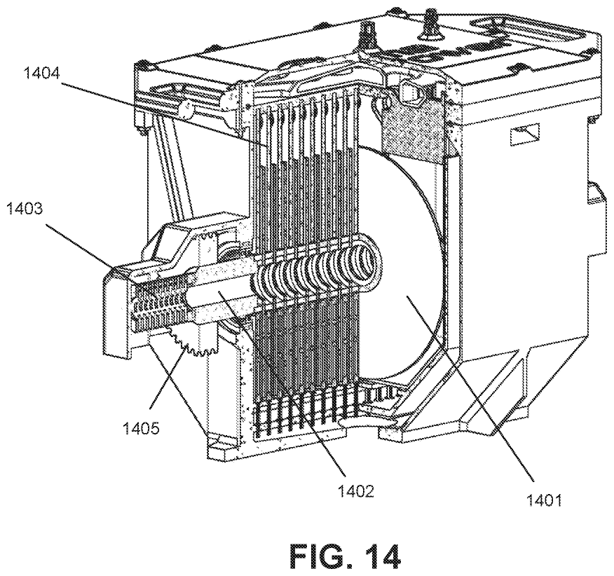

Referring to FIG. 13 and FIG. 14, cathodes 1301 are ganged up inside a housing that provides for liquid electrolyte containment in cathode chambers 1404. The disc anodes 1401 are mounted between the cathodes 1301, each mounted on a common shaft 1402 directly driving from one single common motor. Electrolyte is pumped into the cathode chambers from a single pump and exits through an overflow just above the top of the disc diameter. When the pump is stopped electrolyte is drained back out of each cathode chamber 1404 through the pump inlet. To facilitate longevity of the cathode materials water is pumped into the cathode chambers 1404 so that both the spun dry disc and opposing cathodes 1301 are now immersed in water. On restart the water is drained back out of the unit into a holding tank to make room for electrolyte pumped in to power the battery.

With reference to FIG. 14, to start the battery, electrolyte is pumped into the cathode chambers 1404 until the disc anodes 1401 is totally or partially submerged in the cathode chamber 1404 depending on the current required from the battery. The pump speed/pressure is controlled to maintain the electrolyte at the full or partial level. The common shaft 1402 is started using a drive gear 1405 and turns at a slow 10 to 200 rpm. Power from each disc anode 1401 is controlled by the amount of disc surface area submerged in the electrolyte. The electric current is routed out of the battery through the common shaft 1402 via an electrical conductor 1403 (e.g., slip ring and brushes). The battery is shut down by first turning off the electrolyte pump allowing the electrolyte to drain out of the battery unit. Next the main drive motor is started and spins up the disc anodes 1401 to over 2500 RPM in order to wipe clean the surface of each disc anode 1401 using centrifugal force.

The battery can be turned on and off in a few seconds and will operate until the aluminum on the disc anode 1401 is used up or the electrolyte is exhausted.

With reference to FIG. 14, one embodiment of a multi disc metal battery system is shown. The metal is a 5000 or 6000 series aluminum discs, bonded or glued to both sides of an injection molded round plastic shaft segment. At the center of the mounting shaft segment is a hole that allows part of the disc to protrude into the center of the shaft. A conductive wire is attached to this disc center and out to either end of the shaft assembly. The common shaft 1402 contains an electrical conductor 1403, for example a slip ring commutator or a slip ring and brushes that electrically connects to a spring-loaded conductor made of wires for each disc assembly while concurrently allowing the shaft to slip or rotate relative to the wires. Current flows from the disc metal to the slip ring on the spin shaft where it flows to a spring-loaded wire that runs on the surface of the ring making an electrical connection that goes out to the cathode chamber 1404 in series or parallel. The metal-on-metal wire to slip ring has been shown to be the best method for transmitting electric power that has low voltage and high currents. Our recent work has shown bundled wire brushes can provide more significant performance over monolithic graphite or composite metal graphite brushes in certain applications. These advantages include higher current density, decreased contact resistance, lower power fluctuations (noise), decreased wear or debris and less sensitivity to environmental effects. This is achieved by spreading the contact force over a larger area with light loaded contact spots on each metal fiber or wire. Materials selection for these brushes have shown that copper on copper is excellent for non-submerged version of the brush with brass being the metal of choice for contact with the electrolyte in the battery. Gold plated wire and surfaces are the best for both submerged and external brush systems. Gold allows for lower brush force with a lower risk of high resistance due to surface contamination.

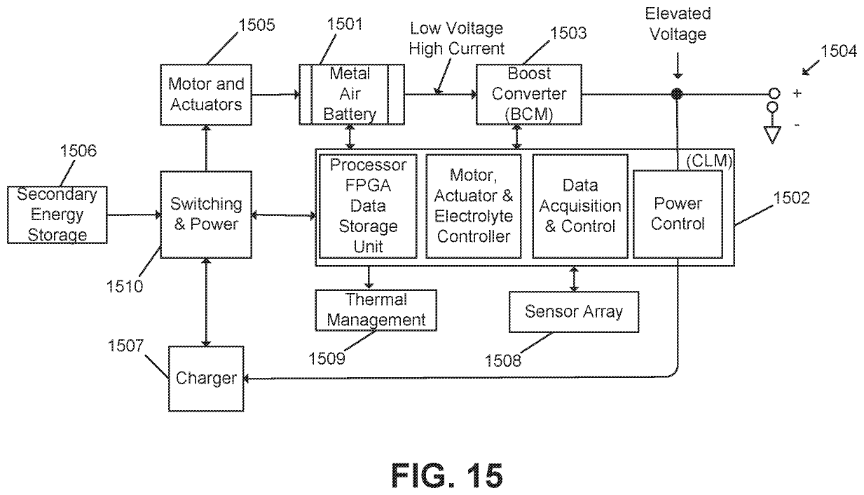

With reference to FIG. 15, one embodiment of the battery control system is depicted in overview. The metal air battery 1501 is the central part of the system. To manage parasitic losses, improve efficiency and reduce the amount of hydrogen generated, a control system is used together with a Secondary Energy Storage (SES) 1506 such as a lithium phosphate battery or a super capacitor.

The use of the Secondary Energy Storage (SES) 1506 powers the controller 1502 on startup before the metal air battery 1501 is started. It is controlled by the controller 1502. It can provide immediate high power for acceleration in electric vehicles and take off in aviation, as an example.

The controller senses and manages the need for different loads and power requirements and provides the necessary power from the Secondary Energy Storage (SES) 1506 or from the metal air battery 1501 or both, as required. This is achieved through the switching and power circuitry 1510 that is run by the controller.

The Secondary Energy Storage (SES) 1506 may comprise of one or more energy blocks that are then charged by the metal air battery 1501 through the charger 1507 and as determined by the controller. The controller senses the capacity of the energy blocks and fills them when the metal air battery 1501 is active. This also allows for immediate start and stop of the metal air battery 1501 on demand. The switching and power circuitry 1510 unit selects the appropriate block in the case of multiple blocks. Thus, one or more of the blocks can be charging while the others are supplying energy to the electrical output 1504 via the BCM 1503.

As the controller 101 is part of the UM 106, it manages the entire battery energy flow in controlled way. It can route and channel energy from the Secondary Energy Storage (SES) 1506 and the metal air battery to the electrical outputs 108 or charge the Secondary Energy Storage (SES) 1506 automatically as determined by the load sense and the state of charge in the Secondary Energy Storage (SES) 1506. By balancing the energy flow, it can minimize parasitic losses from motors, for example, and reduce the hydrogen generation by starting and stopping the metal air battery when needed. Thus, the energy is derived and balanced from both the Secondary Energy Storage (SES) 1506 and the metal air battery.

Referring to FIG. 15, the controller 1502 is comprised of several elements that include the computer processor/FPGA with its associated data storage unit and circuitry that interfaces with motors, actuators, valves 1505, 209, 204 and pumps that form the electrolyte controller 207 and the controller 1502.

A data acquisition and control system interfaces with a sensor array 1508 that provides the computer processor information such as temperature, voltages, currents and flows in the system.

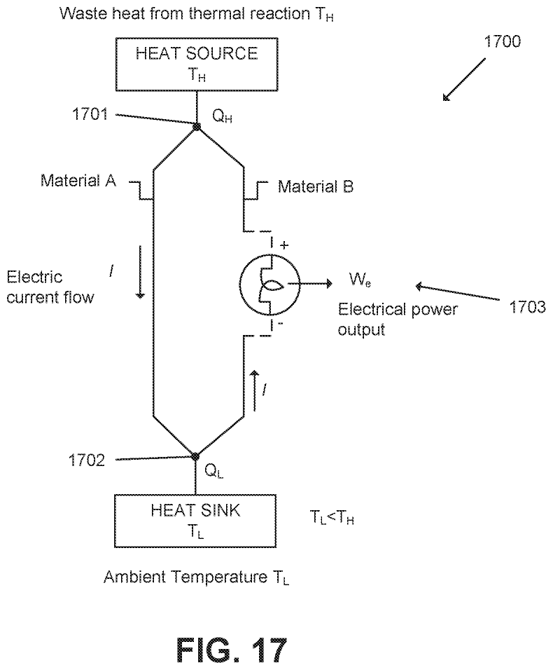

A thermal management system 1509 is an integral part of the system with its associated circuitry and algorithms to manage the heat and parasitic losses in the unit. The thermal management system comprises control algorithms, data from sensors and outputs that sense and control the thermal flow in the system routing the waste heat to components like the TEG in FIG. 17 for reuse.

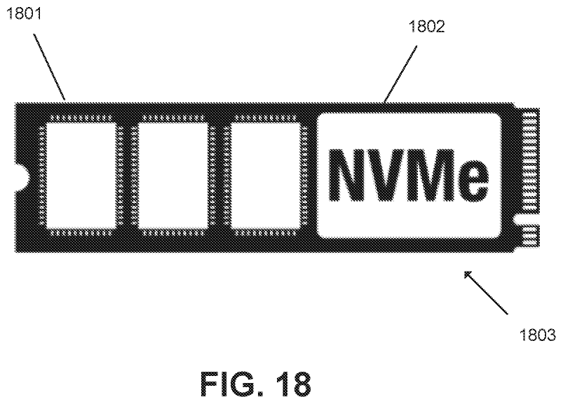

The computer processor/FPGA and its associated data storage unit FIG. 18 run the algorithms and software that control and optimize the energy flow in the system, utilizing Machine Learning Algorithms where appropriate.

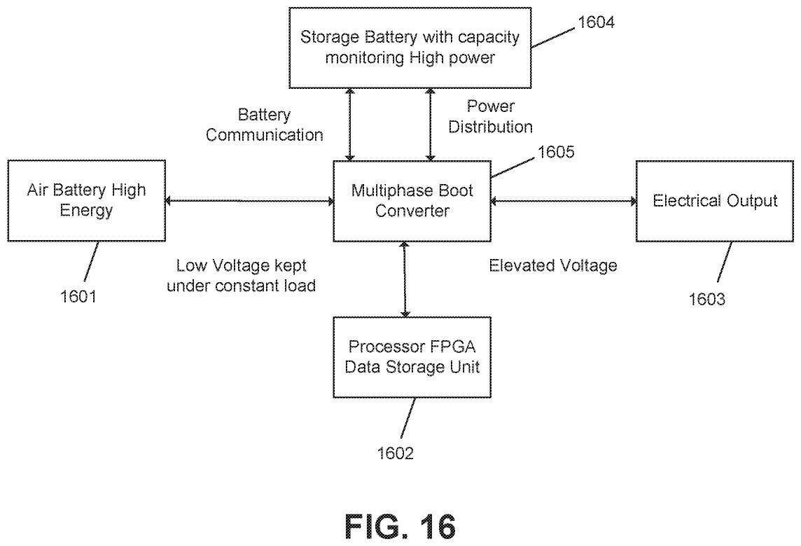

FIG. 16 is an overview of the whole system where a metal air battery 1601 feeds the BCM 1605 with its inherent low voltage but high currents. The BCM 1605 also receives and manages energy from the Secondary Energy Storage (SES) 1506 like a lithium phosphate battery or a supercapacitor 1604 that is then fed to the electrical output 1603 after boosting the voltage to the level that the load requires. In one embodiment, the BCM 1605 is a computer processor controlled multiphase BCM that is used to reduce IR losses and to manage the heavy currents that flow through the system. A multiphase system allows for the currents and voltages to be better managed, with each phase sharing in the load by distributing them over the phases which may be 90 degrees out relative to each other. The output from each phase is then merged to form the total output power. The BCM 1605 can communicate serially with the Secondary Energy Storage (SES) 1506 to read its capacity and to switch in/out different SES blocks. The BCM 1605 also senses and controls the outputs to the electrical output 1603.

The computer processor/FPGA 1602 with its associated data storage unit is used to manage and optimize the whole configuration, optimizing for reduced IR losses, parasitic losses and spurious hydrogen generation.

FIG. 17 is an overview of a thermoelectric generator device 1700 which converts a temperature differential into electrical power. This system leverages the Peltier effect that takes place when two different semiconductors are sandwiched together and waste heat T_{H} is applied at the hot junction 1701 and ambient temperature T_{L} is applied to the cold junction 1702 producing electricity at the power output 1703 when T_{L}<TH.

FIG. 18 is an example of a data store which may contain one or more NAND flash circuits 1801 on a substrate or carrier. NAND flash is non-volatile memory and thus can store data for a very long time. This data may be modified when needed. A NVME controller 1802 is used to manage the flow of data between the NAND flash devices and the system bus 1803.

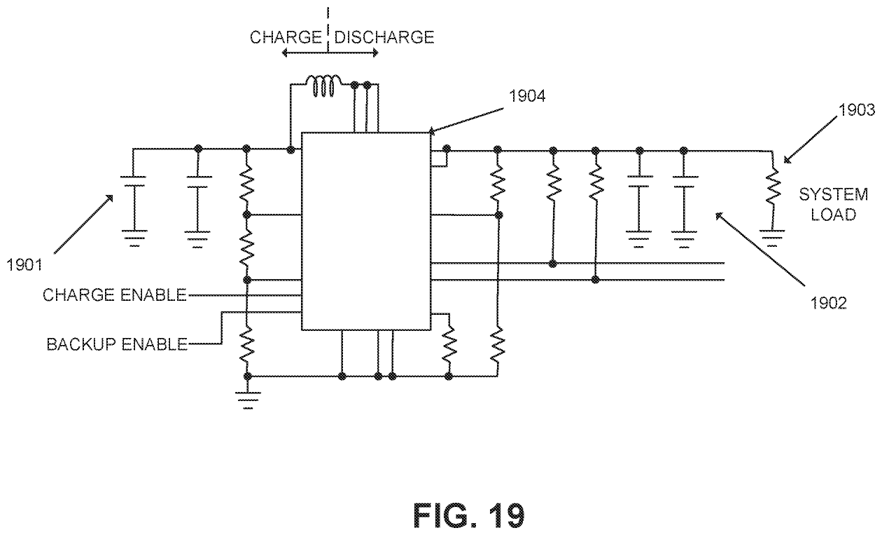

FIG. 19 is and an example of a supercapacitor 1901 also called a supercap with its charge controller 1904. The battery 1902 could be used to buffer the voltage during spikes. The system load 1903 is also shown.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for operating a metal air battery, the method comprising:
monitoring output voltage at an electrical output of a metal air battery, the metal air battery comprising:
an array of cells, each cell comprising a first electrode and a second electrode, wherein the first electrode and the second electrode are selected from an anode and a cathode:
an electrolyte controller configured to provide electrolyte to each cell in the array of cells at an idiosyncratic flow rate and an idiosyncratic electrolyte level for each cell;
a disk drive motor controller configured to rotate each first electrode in the array of cells at an idiosyncratic rotation rate;
altering at least one operational parameter for at least one cell, but fewer than all cells, in the array of cells based on the monitoring, wherein the operational parameter is selected from a group consisting of the idiosyncratic flow rate, the idiosyncratic rotation rate, the idiosyncratic electrolyte level and combinations thereof.

2. A method for operating a metal air battery, the method comprising:
monitoring output voltage at an electrical output of a metal air battery, the metal air battery comprising:
an array of cells, each cell comprising a first electrode and a second electrode, wherein the first electrode and the second electrode are selected from an anode and a cathode;
an electrolyte controller configured to provide electrolyte to each cell in the array of cells at an idiosyncratic flow rate and an idiosyncratic electrolyte level for each cell;
a disk drive motor controller configured to rotate each first electrode in the array of cells at an idiosyncratic rotation rate;
a cell load module (CLM) disposed between the array of cells and the electrical output configured to vary resistive load applied to each cell in the array of cells at an idiosyncratic resistive load;
altering at least one operational parameter for at least one cell, but fewer than all cells, in the array of cells based on the monitoring, wherein the operational parameter is selected from a group consisting of the idiosyncratic flow rate, the idiosyncratic rotation rate, the idiosyncratic electrolyte level, the idiosyncratic resistive load and combinations thereof.

3. A method for operating a metal air battery, the method comprising:
monitoring output voltage at an electrical output of a metal air battery, the metal air battery comprising:
an array of cells, each cell comprising a first electrode and a second electrode, wherein the first electrode and the second electrode are selected from an anode and a cathode;
an electrolyte controller configured to provide electrolyte to each cell in the array of cells at an idiosyncratic flow rate and an idiosyncratic electrolyte level for each cell;
a disk drive motor controller configured to rotate each first electrode in the array of cells at an idiosyncratic rotation rate;
a cell load module (CLM) disposed between the array of cells and the electrical output configured to vary resistive load applied to each cell in the array of cells at an idiosyncratic resistive load;
a boost control module (BCM) disposed between the array of cells and the electrical output configured to boost the voltage of each cell in the array of cells at an idiosyncratic boost control level;
altering at least one operational parameter for at least one cell, but fewer than all cells, in the array of cells based on the monitoring, wherein the operational parameter is selected from a group consisting of the idiosyncratic flow rate, the idiosyncratic rotation rate, the idiosyncratic electrolyte level, the idiosyncratic resistive load, the idiosyncratic boost control level and combinations thereof.

4. The method as recited in claim 1, wherein the metal air battery further comprises a computer processor and data storage unit that executes machine learning software, wherein the machine learning software uses the machine learning to optimize the at least one operational parameter for at least one cell to achieve a predetermined electrical output.

5. The method as recited in claim 1, wherein the metal air battery further comprises a computer processor and data storage unit that stores the at least one operational parameter for each cell in the array of cells to provide stored parameters.

6. The method as recited in claim 5, further comprising transmitting the stored parameters to a remote data processing center.

7. The method as recited in claim 1, wherein the array of cells comprises a first cell, the method further comprising turning the first cell off by (1) altering the idiosyncratic flow rate to the first cell to remove electrolyte from the first cell and (2) spinning an electrode of the first cell at a rate of at least 10 revolutions per minute.

8. The method as recited in claim 7, wherein the rate is at least 1000 revolutions per minute.

9. A metal air battery comprising:
an array of cells, each cell comprising a first electrode and a second electrode one of which rotates relative to the other, wherein the first electrode and the second electrode are selected from an anode and a cathode;
an electrolyte controller configured to provide electrolyte to each cell in the array of cells at an idiosyncratic flow rate and an idiosyncratic electrolyte level for each cell; and
a disk drive motor controller configured to rotate each first electrode in the array of cells at an idiosyncratic rotation rate.

10. The metal air battery as recited in claim 9, wherein each first electrode in the array of cells is connected to a common shaft.

11. The metal air battery as recited in claim 9, wherein each first electrode has a surface that is spaced from each second electrode by a distance of between 0.5 mm and 4 mm.

12. The metal air battery as recited in claim 9, wherein each first electrode is double sided such that galvanic corrosion occurs on both sides of the first electrode during operation of the metal air battery.

13. The metal air battery as recited in claim 9, wherein the metal air battery further comprises a boost control module (BCM) disposed between the array of cells and the electrical output configured to boost voltage of each cell in the array of cells at an idiosyncratic boost control level for each cell.

14. The metal air battery as recited in claim 9, wherein the metal air battery further comprises a cell load module (CLM) disposed between the array of cells and the electrical output configured to vary resistive load applied to each cell in the array of cells at an idiosyncratic resistive load for each cell.

15. The metal air battery as recited in claim 13, wherein the metal air battery further comprises a cell load module (CLM) disposed between the array of cells and the boost control module (BCM) configured to vary resistive load applied to each cell in the array of cells at an idiosyncratic resistive load for each cell.

16. The metal air battery as recited in claim 15, wherein the metal air battery further comprises at least one thermoelectric generator device to convert heat from the metal air battery into electrical energy to improve efficiency of the metal air battery.

17. The metal air battery as recited in claim 15, wherein the metal air battery further comprises a supercapacitor to manage short term load spikes upon the metal air battery.

18. The metal air battery as recited in claim 9, wherein the metal air battery further comprises a data storage unit for the purposes of storing operating parameters to optimize future operating performance.
